(19) United States
(12) Patent Application Publication
(10) Pub. No.: US 2026/0276991 A1
(43) Pub. Date: Sep. 17, 2026

(54) MANUFACTURABLE DIFFRACTIVE STRUCTURES WITH SMOOTHLY VARYING PROPERTIES

(71) Applicant: Snap Inc., Santa Monica, CA (US)

(72) Inventors: David Nicholas Crosby, Oxford (GB); Roland Piper, London (GB); Matthew Proctor, Reading (GB)

(21) Appl. No.: 19/079,056

(22) Filed: Mar. 13, 2025

(51) Int. Cl. G02B 27/01

(52) U.S. Cl. CPC G02B 27/0172; G02B 2027/0123

(57) ABSTRACT

A waveguide includes a first region with a plurality of first diffractive structures and a second region with a plurality of second diffractive structures. The first and second diffractive structures have first and second values of a first physical property giving rise to a first and second values of an optical property in the respective regions. The waveguide also includes at least one interstitial region located between the first region and the second region, with a plurality of interstitial diffractive structures. Each interstitial diffractive structure has a value of at least one additional physical property giving rise to an intermediate value of the optical property in the at least one interstitial region that is between the first value and the second value of the optical property.

### TECHNICAL FIELD

The present disclosure relates generally to optical diffraction gratings and, more particularly, to optical diffraction gratings on waveguide surfaces having diffractive structures with smoothly varying optical properties that obey manufacturing constraints.

### BACKGROUND

Waveguides, also referred to as lightguides, are optical components that guide light from a light source to the viewer's eye. They are used in various display systems, including augmented reality (AR) and virtual reality (VR) (jointly, extended reality (XR)) headsets, where compactness and the ability to direct light efficiently are crucial.

Some waveguides incorporate patterns of diffractive optical structures, such as diffraction gratings, to couple light into and/or out of the waveguide. These waveguides can be referred to as diffractive waveguide combiners (DWCs). DWCs utilize diffractive optical elements (DOEs) positioned on or in a light-guiding substrate to manipulate and direct light. DWCs typically consist of multiple DOEs, each serving specific functions to change the direction of light propagation, either within the plane of the waveguide, into the waveguide (in-coupling), or out of the waveguide (out-coupling) The performance of DWCs depends on the precise design and fabrication of the diffractive structures of the DOEs, which can include features at the nanometer scale. The behavior of light interacting with these structures is governed by principles of diffraction and can be described using methods such as electromagnetic simulation and Jones calculus. The field of DWC technology involves ongoing research and development to improve factors such as efficiency, uniformity of color and brightness, transparency and non-interference with the real-world field of view, and reduction of optical artifacts.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 illustrates a perspective view of a projector and waveguide, showing light propagated toward an eye, in accordance with some examples.

FIG. 2 illustrates a perspective view of a first example of a diffractive structure, in accordance with some examples.

FIG. 3 illustrates a perspective view of a second example of a diffractive structure, in accordance with some examples.

FIG. 4 illustrates a top view of an example of multiple regions of a diffraction grating on a waveguide, in accordance with some examples.

FIG. 5 illustrates a top view of a second example of multiple regions of a diffraction grating on a waveguide, showing potential placement of interstitial regions, in accordance with some examples.

FIG. 6 illustrates a top view of four different diffractive structures in four regions of a hypothetical waveguide and hypothetical transitions between these regions if unconstrained by manufacturability, in accordance with some examples.

FIG. 7 is a pair of graphs showing a non-manufacturable gradual change of gap widths replaced by a manufacturable change in gap depth, in accordance with some examples.

FIG. 8 is a pair of graphs showing a non-manufacturable gradual change of the width of a raised portion of a structure replaced by a manufacturable change in the height of the raised portion of the structure, in accordance with some examples.

FIG. 9A illustrates a side cross-sectional view of a blazed diffractive structure showing a sidewall angle and a blaze angle of the structure, in accordance with some examples.

FIG. 9B illustrates a side cross-sectional view of a multi-height stepped diffractive structure showing a sidewall angle and a pseudo-blaze angle of the structure, in accordance with some examples.

FIG. 10 illustrates a top view of a multi-height diffractive structure varied between two regions to have different depths of a narrow depression to join structures into grating lines, in accordance with some examples.

FIG. 11 illustrates a top view of a multi-height diffractive structure varied between two regions to have different lengths of channels to separate 1D grating lines into discrete structures of a 2D lattice, in accordance with some examples.

FIG. 12 illustrates a top view of a unit cell of a diffractive lattice showing five diffractive structures joined by diagonal blend bridges, in accordance with some examples.

FIG. 13 illustrates a top view of a unit cell of a diffractive lattice showing five diffractive structures joined by H-shaped blend bridges, in accordance with some examples.

FIG. 14 is a flowchart showing operations of a method for manufacturing a waveguide, in accordance with some examples.

### DETAILED DESCRIPTION

Examples described herein relate to diffractive waveguide combiners (DWCs) having multiple regions—such as multiple DOEs, or multiple regions within a given DOE—that exhibit different diffractive properties. The use of multiple regions can result in step changes in diffractive structure parameters across the surface of the waveguide. These abrupt transitions can lead to unwanted optical effects, such as visible boundaries to outside observers or reduced display performance.

To address these issues, the described technology introduces interstitial diffractive structures between regions of distinct diffractive structures. These intermediate structures are created by varying physical parameters such as duty cycle, orientation, height, and coating thickness. The interstitial structures are designed to provide a smooth transition in optical properties between different regions of the waveguide as a result of smoothly modulated values of their physical properties.

In some cases, however, manufacturing constraints present challenges to the implementation of smoothly modulated physical properties. The etching, coating, and imprinting processes typically used to manufacture nanoscale structures on waveguides are constrained by the physical limits of the processes: physical properties such as the width and depth of etches, the height to width ratio or other aspect ratio of structures, and the thickness and refractive index of deposited coatings are all constrained to certain minima and/or maxima in practical terms. Other manufacturing parameters, such as the number of etches, the materials used, or the type of etching, can result in more or less difficulty in manufacturing in terms of time, money, yield, and other resource constraints. In this disclosure, the terms “manufacturable”, “manufacturability”, “ease of manufacture”, “difficulty to manufacture”, and so on refer to either hard or soft limits on fabrication or manufacture of a physical object, such as whether existing fabrication techniques can make the object at all, whether the resources required to fabricate the object reliably allow fabrication to be commercially practical and/or whether such resource requirements are greater or less than those required for the fabrication of alternative objects being considered in a given case. Thus, in some cases, implementing a smooth gradient of a given physical property between diffractive structures of a first region and diffractive structures of a second region can result in a waveguide design that is difficult or impossible to manufacture using known techniques. This means that the conventional approach to implementing a smooth gradient of the corresponding desired optical property may be impractical or impossible using conventional design and manufacturing techniques.

In examples described herein, the technical problem of how to achieve a smoothly modulated desired optical property is addressed by identifying one or more additional physical properties that can be modulated to give rise to modulation of the desired optical property, where these additional physical properties can be modulated while satisfying manufacturability constraints. Thus, one or a combination of unconstrained physical parameters can be used as a proxy for physical parameters that are constrained in a given intermediate or interstitial region. The smooth modulation of these physical parameters from one region to another may be referred to herein as a “blend” between the two regions. For example, the duty cycle of an etching process and the depth of the etching process could be modulated from a first region to a second region, resulting in a combined etching depth (or height) and duty cycle blend between the two regions.

For instance, when transitioning from a region with a one-dimensional structure with a 0% duty cycle to another region where the structure has a 40% duty cycle, a structure with a channel width smaller than the minimum (as dictated by manufacturing constraints) might be required. To overcome this manufacturing constraint, examples described herein can provide a combined height and duty cycle blend that respects the minimum channel width limit.

Another example involves transitioning from a three-level structure to a two-level structure by smoothly modulating the width of the top step from a zero value in the first region to a maximum value in the second region. In this case, examples described herein can employ a “top step blending” technique. This technique avoids exceeding aspect ratio manufacturability limits by shrinking the height of the top step to compensate for the transition.

The described examples also address more complex transitions, such as those between 2D and 1D structures. These transitions may require changes in multiple parameters simultaneously. A combination of blending techniques can be employed for these purposes, including blends of two or more of the following physical properties:
1. Depths of channels between structures
2. Height variation of structures
3. Height variation of portions of multi-height structures
4. Length of channels at full depth across full duty cycles
5. Use of permanent narrow bridges that link islands of material and change orientation, width, and height as required by the positions of the island structures within a unit cell
6. Sidewall angle variation on any side of each structure
7. Curvature and gradient of sidewalls toward the bottom of etches
8. Gradual rounding of corners
9. Blaze angle adjustments of stepped structures
10. Changes in structure orientation within the unit cell
11. Modifications to coating thickness
12. Modifications to coating refractive index

By combining these techniques, some examples allow for multi-parameter changes that provide smooth transitions between the optical behavior of different structures.

In some examples, as noted above, individual structures can be linked together by narrow bridges that change in their dimensions as the relative positions of the structures change. This approach may be referred to herein as “blended bridges” or “blend bridges”. These bridges link individual structures, which may be referred to as islands, providing a raised bridge structure that never diminishes in height or width below certain minimum values, but may increase in height, width, and/or length, and may change in shape, as the islands joined together by the bridge approach each other. In some cases, the bridge may provide a continuous transition of optical properties as the width of a gap or channel between the two structures approaches zero or approaches a minimum value dictated by manufacturability constraints.

Thus, examples described herein can provide technical solutions to technical challenges in DWC design and manufacturing, potentially improving the optical display performance and/or cosmetic appearance of diffractive waveguide devices.

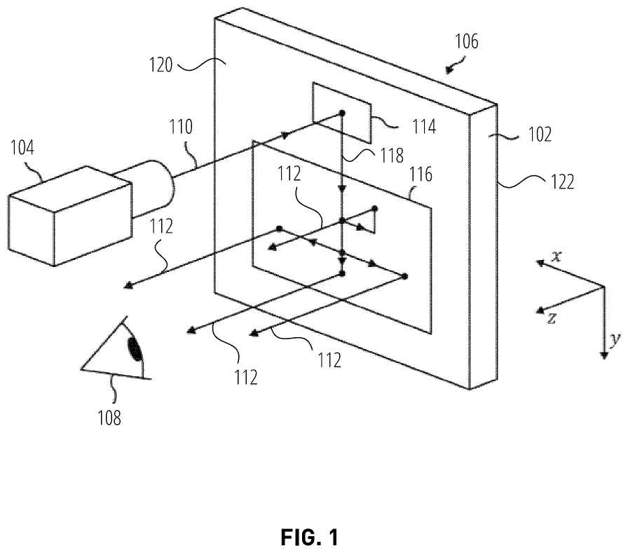

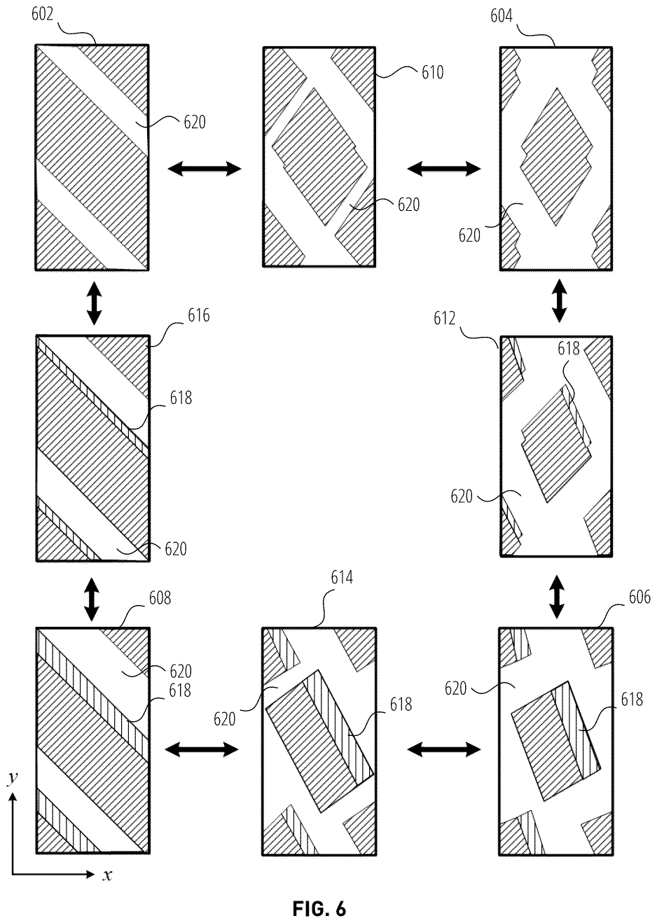

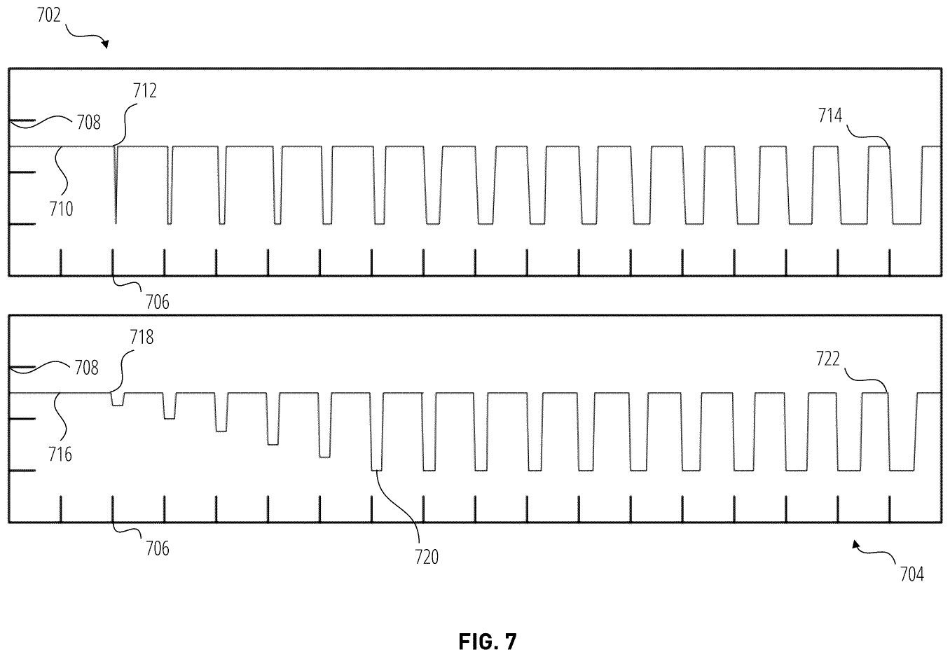

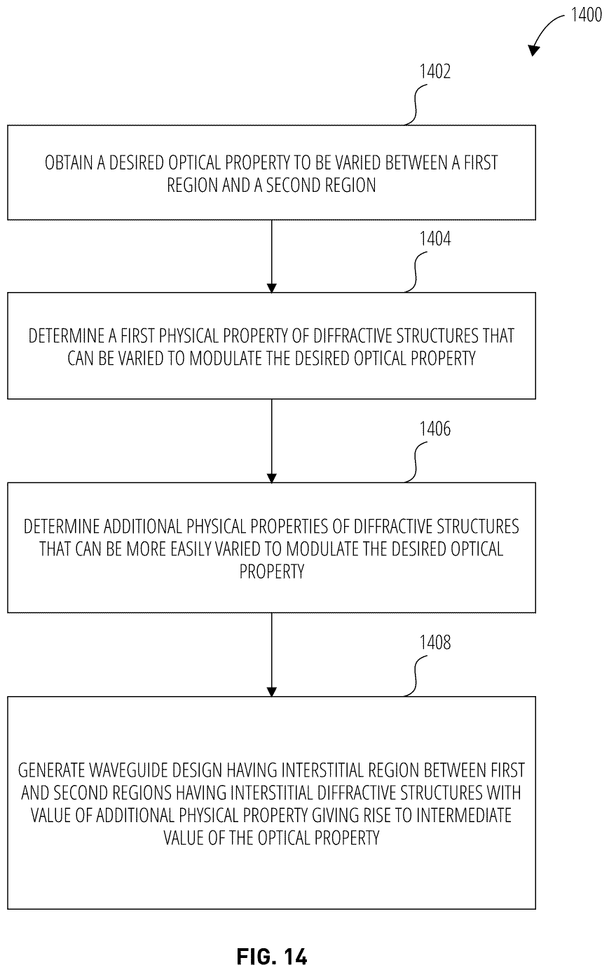

FIG. 1 through FIG. 5 below show examples of display devices, waveguides, diffractive structures, and diffraction gratings to which example interstitial regions, interstitial diffractive structures, and associated methods can be applied. FIG. 6 shows an example of different types of diffractive structures in different regions and hypothetical transitions between the regions unconstrained by manufacturing constraints. FIG. 7 through FIG. 13 show different approaches to modulating additional physical parameters as proxies for a first physical parameter in order to simplify or assist manufacturability. FIG. 14 shows a method for designing and manufacturing a diffractive waveguide according to the techniques described herein.

FIG. 1 shows a perspective view of a projector 104 emitting projected light 110 (represented in FIG. 1 as a single ray) into a display device 106.

The display device 106 includes a waveguide 102 or light guide. The waveguide 102 guides light via repeated total internal reflections from opposing surfaces of the waveguide 102. In the configuration of FIG. 1, the waveguide 102 can be configured as a planar waveguide or a slab waveguide, such as disposed in the x-y plane. The surfaces can be generally flat or planar surfaces that are parallel to each other and extend in the x-y plane, although in some cases the surface may exhibit curvature. One of the surfaces (e.g., the display surface 120) can face an eye 108 of the user. The other of the surfaces (e.g., opposite surface 122) can face away from the eye 108 of the user.

The waveguide 102 can include one or more diffractive and/or reflective structures, which can receive the projected light 110 from the projector 104, redirect the projected light 110 internally within the waveguide 102, and extract the projected light 110 from the waveguide 102 to form exiting light 112. For example, the waveguide 102 can include one or more diffraction gratings and/or diffraction grating regions, such as a single diffraction grating structure that has individual regions that can function as if they were separate diffraction gratings. The waveguide 102 can include one or more reflective structures, such as mirrors, prisms, and/or reflective gratings. The waveguide 102 can include one or more transmissive structures, such as transmissive gratings. The waveguide 102 can optionally include one or more light-focusing (or collimation-changing) optical elements, such as lenses. Any or all of these structures or elements can be included on one or both surfaces of the waveguide 102 or in an interior of the waveguide 102.

In the configuration of FIG. 1, the waveguide 102 can include an input grating 114, which can receive the projected light 110 from the left projector 104 and direct the projected light 110 into the waveguide 102 to form light 118. The waveguide 102 can include an output grating 116, which can receive the light 118, split and redirect the light 118 internally to extend over a relatively large area (compared to the input grating 114), and direct the light 118 out of the waveguide 102 to form the exiting light 112. The terms “grating” or “diffraction grating” are used herein to refer to any pattern of diffractive structures or diffractive features. In some examples, the input grating 114 can be replaced with any component that couples light into the waveguide 102 such that the light propagates within the waveguide 102 by total internal reflection (TIR). The redirections and splitting can occur from multiple (sequential) interactions with a single diffraction grating, or from sequential interactions with different gratings that are disposed within the surface area of the output grating 116. For example, a light ray can be diffracted into the waveguide by the input grating 114 and be caused to totally internally reflect from one surface of the waveguide 102 to the other in a direction toward the output grating 116. The light 118 may then interact with diffractive features of the output grating 116 on or within the waveguide. A portion of light 118 is diffracted laterally within the plane of the waveguide thereby replicating the image across the area of the output grating 116, due to multiple interactions with diffractive features that exist across the output grating 116. Another portion of light 118 is directed out of the waveguide by diffraction grating 116 toward the eye 108 as light 112. The interactions with the diffractive features of the output grating 116 can cause internal rays or internal light beams in the waveguide 102 to change direction within the waveguide 102. Eventually, the interactions with the diffractive features can cause the internal rays or internal light beams to exit the waveguide 102 to propagate toward the eye 108 of the user.

In some examples, the waveguide 102 can be configured to operate at infinite conjugates. For example, the projector 104 may project light that forms an image infinitely far away, so that the light would appear in focus on a screen placed relatively far from the projector 104. Similarly, the output grating 116 may direct the exiting light 112 toward the eye in such a manner that the image appears to be infinitely far away to the eye 108 of the user. For such an infinite-conjugate arrangement, angles in the space of the light that enters and exits the waveguide 102 can correspond uniquely to image locations in the image. For example, the propagation angles of the light can map uniquely to the propagation angles of the exiting light 112, which in turn can map uniquely to the image locations in the image at the retina of the eye 108 of the user.

The waveguide 102 can make use of this infinite-conjugate relationship to perform so-called “pupil replication” or “pupil expansion”. The projector 104 can be configured to have an exit pupil that coincides with the input grating 114. The internal splitting and redirections within the output grating 116 can effectively expand a surface area of the exit pupil, while maintaining the unique mapping of propagation angle to image location for light in the pupil, and thereby maintaining the unique mapping of virtual image surface location to image location. The size of the output grating 116 (e.g., an area covered by the replicated pupils, as constrained within a surface area of the output grating 116) can be larger than a pupil of the eye 108 of the user, so that if the pupil of the eye 108 moves, such as caused by the user changing a gaze direction, the amount of light entering the pupil of the eye 108 may not vary significantly, and the user may not perceive a change in brightness of the image.

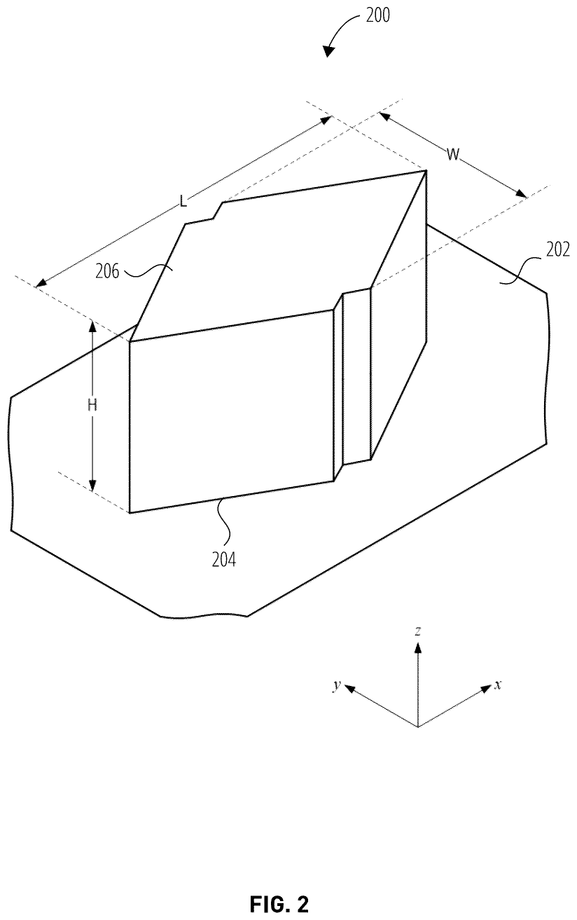

FIG. 2 shows a perspective view of an example of a diffractive structure 200.

In some examples, the diffractive structure 200 can be formed as a protrusion that extends outward from the waveguide on the surface 202 of the waveguide, with a specified height H. Alternatively, the diffractive structure 200 can be formed as an indentation that extends inward into an interior of the waveguide from the surface 202 of the waveguide, with a specified depth (not shown).

In some examples, the diffractive structure 200 can be formed from one or more materials that form the interior of the waveguide. For example, diffractive structure 200 can be defined using a lithographic etching process to define a shape of the diffractive structure 200 from a material of the waveguide.

In some examples, the diffractive structure 200 can be formed from one or more materials that are different from the one or more materials that form the interior of the waveguide. For example, the diffractive structure 200 can be formed by using a deposition process to deposit one or more materials to define the shape of the diffractive structure 200. In some examples, the deposition process includes etching into a substrate, deposition of material, and imprinting using the etched substrate (or a negative or positive copy thereof). In some examples, the diffractive structure 200 can be formed by etching into a substrate formed over the waveguide, or into the waveguide itself.

In some examples, the diffractive structure 200 can be formed using a lithographic process. The lithographic process can use a mask to define a footprint, or a lateral extent (e.g., in the x-y plane) of the diffractive structure 200. The mask can define a perimeter 204 of the diffractive structure 200, such that the perimeter 204 determines the footprint of the diffractive structure 200 as being a surface area of the diffractive structure 200 in an interior of the perimeter 204. The lithographic process can use one or more etch steps to remove material corresponding to an interior of the perimeter 204 of the diffractive structure 200 or an exterior of the perimeter 204 of the diffractive structure 200. In some examples, the lithographic process can use a single etch step, which can form the diffractive structure 200 with a specified height (or depth) on a feature surface 206. The feature surface 206 can be generally parallel to the surface 202 of the waveguide and longitudinally offset (e.g. along the z-direction) from the surface 202 of the waveguide by the specified height (or depth) that can be determined from a time duration of the etch step.

In the example of FIG. 2, the diffractive structure 200 can be formed by a lithographic process that uses a single etch step. The single etch step can produce a feature surface 206 that can be parallel or generally parallel to the surface 202 of the waveguide. The feature surface 206 can be offset by a height H from the surface 202 of the waveguide. The height H can be less than a wavelength of the light guided by the waveguide.

In the example of FIG. 2, the lithographic process can use a mask that defines the perimeter 204 of the diffractive structure 200. In the example of FIG. 2, the perimeter 204 of the diffractive structure 200 can be shaped as a notched diamond (e.g., shaped generally as a parallelogram in which a pair of opposing corners are bent inward). The perimeter 204 can be defined by a length L and a width W. The length L can be less than the wavelength of the light guided by the waveguide. The width W can be less than the wavelength of the light guided by the waveguide. In some examples, one or both of the length L or the width W can optionally be greater than the wavelength of the light guided by the waveguide. In some examples, a periodically repeating unit cell of a diffraction grating or lattice contains a single diffractive structure 200 and has at least one dimension (e.g., a length and/or width) that is less than the wavelength of the light guided by the waveguide.

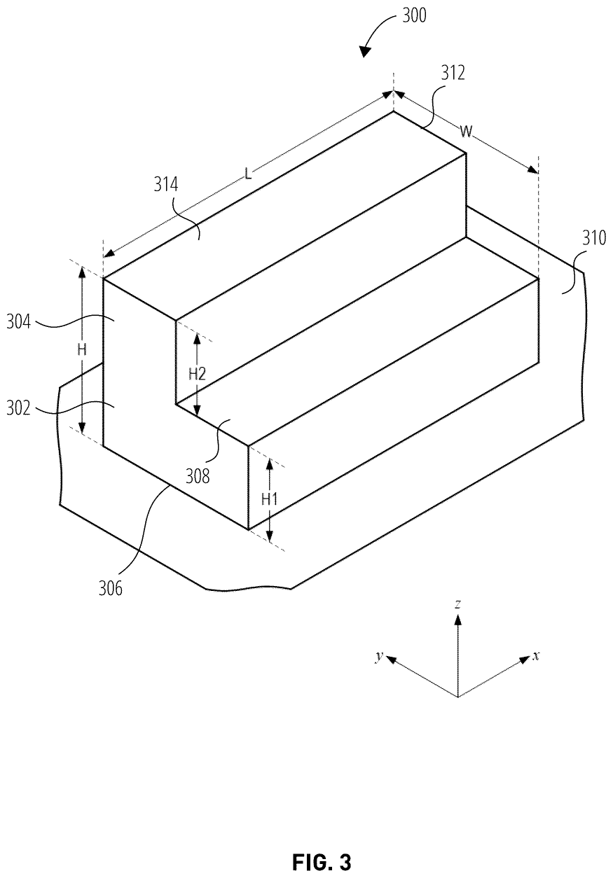

FIG. 3 shows a perspective view of another example of a diffractive structure 300.

In the example of FIG. 3, the diffractive structure 300 can be formed by a lithographic process that uses multiple masks and multiple etch steps to create more complicated structures for the diffractive structure 300. For example, the diffractive structure 300 of FIG. 3 can include two levels, which can be formed with a two-step etching process. The two-step etching process can form a first level 302 and a second level 304. In some examples, the first level 302 can be formed before the second level. In other examples, the second level 304 can be formed before the first level 302. In some examples, the diffractive structure 300 and/or other diffractive structures and/or nanostructures described herein can be formed by etching a master template for a pattern of such features (e.g., a grating or a portion of a grating), then using the template (or a stamp formed from the master template) to imprint the shapes of the features into a material (such as a resin) on the waveguide surface to form the pattern of features. In some examples, the master template can include positive copies of the features; in other examples, the master template can include negative copies of the features. Stamps can be formed as positive or negative copies, and the final imprinting step to form the pattern of features on the waveguide surface is performed using a negative of the pattern of features.

The first level 302 can have a first perimeter 306 defined by a first mask during the two-step etching process. The first level 302 can have a first surface 308 defined by a time duration of a first etching step during the two-step etching process. The first surface 308 can be offset longitudinally (e.g., along the z-direction) by a height H1 from a surface 310 of the waveguide.

The second level 304 can have a second perimeter 312 defined by a second mask during the two-step etching process. In some examples, the second perimeter 312 can be disposed at least partially within an interior of the first perimeter 306. The second level 304 can have a second surface 314 defined by a time duration of a second etching step during the two-step etching process. The second surface 314 can be offset longitudinally (e.g., along the z-direction) by a height H2 from the first surface 308 and offset longitudinally by a height H from the surface 310 of the waveguide.

In the example of FIG. 3, the footprint of the diffractive structure 300 is defined by the first perimeter 306. In the example of FIG. 3, the first perimeter 306 can be rectangular or generally rectangular. As with diffractive structure 200, the perimeter of diffractive structure 300 can be defined by a length L and a width W. The length L can be less than the wavelength of the light guided by the waveguide. The width W can be less than the wavelength of the light guided by the waveguide. In some examples, one or both of the length L or the width W can optionally be greater than the wavelength of the light guided by the waveguide. In some examples, a periodically repeating unit cell of a diffraction grating or lattice contains a single diffractive structure 300 and has at least one dimension (e.g., a length and/or width) that is less than the wavelength of the light guided by the waveguide.

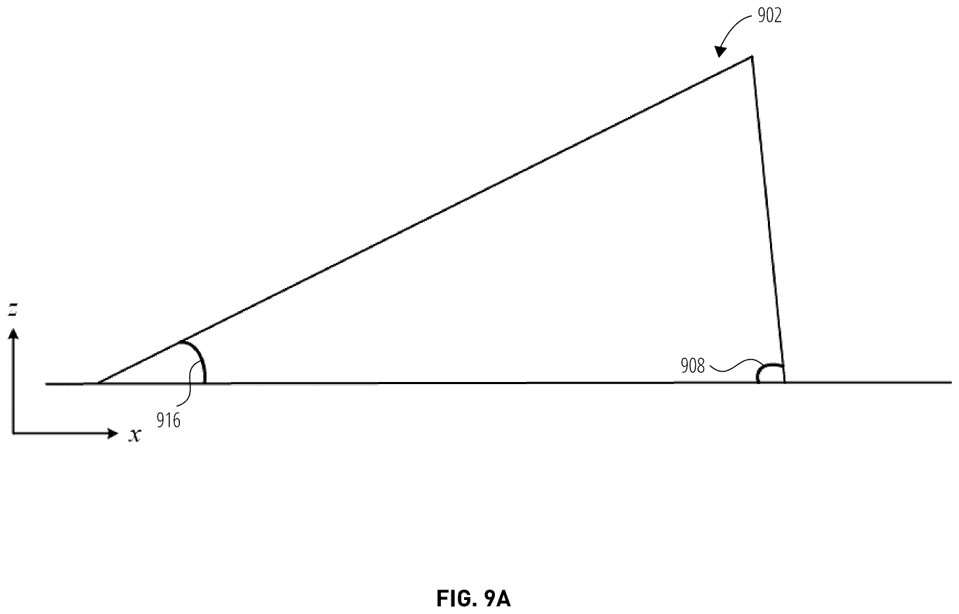

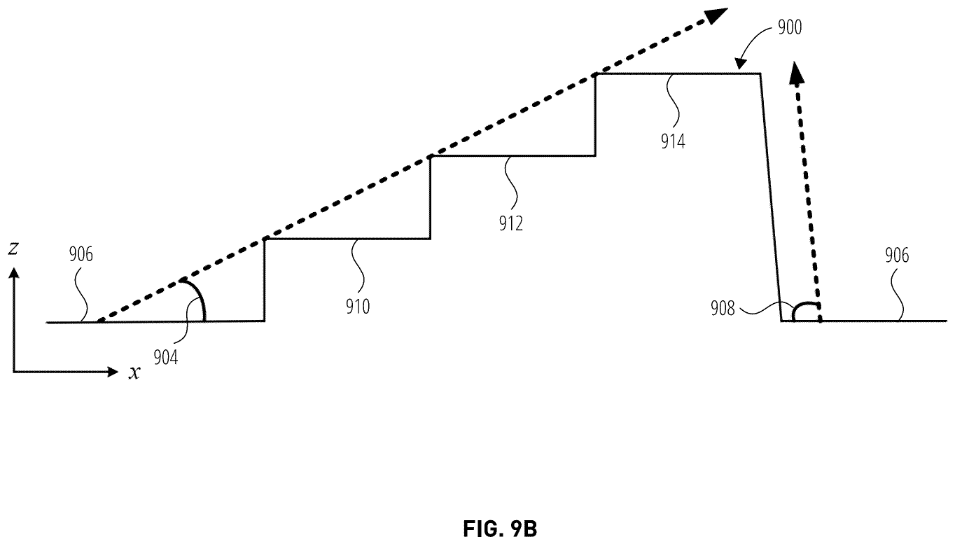

In general, the structure of the diffractive structure, including its physical and material geometry, can determine its diffractive properties. For example, the size and shape of the diffraction grating feature can, in part, determine the diffraction efficiencies of its diffracted orders. In other words, the size and shape of the diffraction grating feature can determine how much light diffracts into each diffracted order. In some examples, it may be desirable to direct light into a specified diffracted order. One technique to affect the diffraction efficiencies is to impart a blaze to the grating. In a blazed diffraction grating, the diffracting surfaces can be angled with respect to a plane of the grating. Because angled surfaces can be difficult to manufacture using standard lithographic etching techniques, the diffraction grating feature can use a step approximation (also known as a binary approximation) of a blazed surface. In the example of example of FIG. 3, the stepped nature of the first surface 308 and the second surface 314 can suitably approximate a blazed surface, and can affect the diffraction efficiencies of the diffracted orders in a manner similar to using an angled blazed surface. Additional examples of blazed diffractive structures and pseudo-blazed stepped diffractive structures are described below with reference to FIG. 9A and FIG. 9B.

The diffractive structures shown in FIG. 2 and FIG. 3 are but mere examples of diffractive structures. Other suitable sizes and shapes can also be used, such as stepped structures having more than two steps, stepped structures with both ascending and descending staircase shapes, and other suitable shapes of diffractive structures.

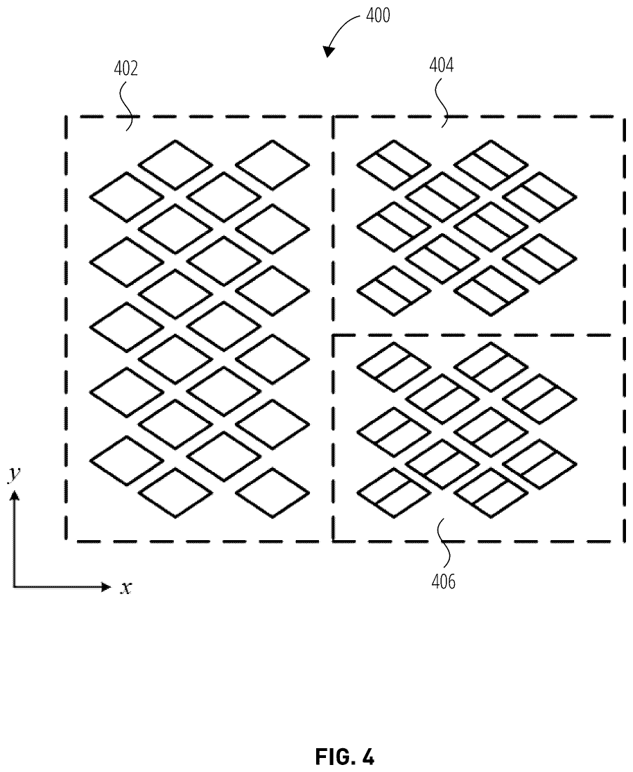

FIG. 4 shows a top top view of an example of one or more portions of a waveguide 400. The one or more portions can be arranged as adjacent regions within a surface area of the waveguide 400. Each region can include diffraction grating features that are spaced apart from other diffraction grating features, such as on a surface of the waveguide 400. More or fewer than three regions can also be used.

The waveguide 400 includes a first portion 402. The first portion 402 can include multiple diffraction grating features, such as diffractive structures 200, that are disposed on or in the waveguide 400 at a corresponding plurality of diffraction grating feature locations over a surface area of the waveguide. In the illustrated example, the diffractive structures 200 are regularly spaced in the surface area of the first portion 402 of the waveguide 400, although in some example gratings the features can be irregularly spaced in a controlled pattern that preserves the image-preserving diffractive effects of a grating with regularly spaced features. In the example of FIG. 4, the diffractive structure 200 can have the same orientation (e.g., in the x-y plane).

The waveguide 400 includes a second portion 404 that adjoins the first portion 402, optionally with an area between the first portion 402 and the second portion 404 that lacks diffractive structures. The second portion 404 can include multiple diffraction grating features, such as diffractive structures 300, that are disposed on or in the waveguide 400 at a corresponding plurality of diffraction grating feature locations over a surface area of the waveguide. In the example of FIG. 4, the diffractive structures 300 are regularly spaced in the surface area of the second portion 404 of the waveguide 400. In the example of FIG. 4, the diffractive structures 300 can have the same orientation (e.g., in the x-y plane).

The waveguide 400 includes a third portion 406 that adjoins at least one of the first portion 402 or the second portion 404, optionally with an area adjacent to the third portion 406 that lacks diffractive structures. The third portion 406 can have multiple diffraction grating features, such as diffractive structures 300, that are disposed on or in the waveguide 400 at a corresponding plurality of diffraction grating feature locations over a surface area of the waveguide. In the example of FIG. 4, the diffractive structures 300 are regularly spaced in the surface area of the third portion 406 of the waveguide 400. In the example of FIG. 4, the diffractive structures 300 can have a first orientation (e.g., in the x-y plane) in the second portion 404, but a second orientation different from the first orientation in the third portion 406.

The regular spacing of the diffractive structures can include a pattern that repeats over at least some of each portion of the waveguide 400. In the example of FIG. 4, the pattern can include a regular spacing along a first linear axis and a second regular spacing along a second linear axis that is angled with respect to the first linear axis. In some examples, the pattern can be rectilinear. The regular spacings shown in FIG. 4 are but one example of locations that are regularly spaced in the surface area of the waveguide 400. Other suitable regularly spaced locations can also be used.

The out-coupling efficiency (also called outcoupling efficiency) of light from the various portions or regions of the waveguide 400 is a function of several factors. The dimensions and shapes of the diffractive structures used within a region affects outcoupling efficiency, as does the spacing and material composition of the diffractive structures to form a lattice or grating. The light propagating within the waveguide 400 interacts with the lattice of diffractive structures in different patterns that may depend on the wavelength of the light, further affecting outcoupling efficiency for light of different wavelengths. Furthermore, the refractive indices of different materials used in the waveguide 400 and the diffraction grating can affect outcoupling efficiency in complex ways due to the nature of total internal reflection (TIR) and how refraction, reflection, and diffraction result in different orders of light propagating with different relative efficiencies within and out of the waveguide 400.

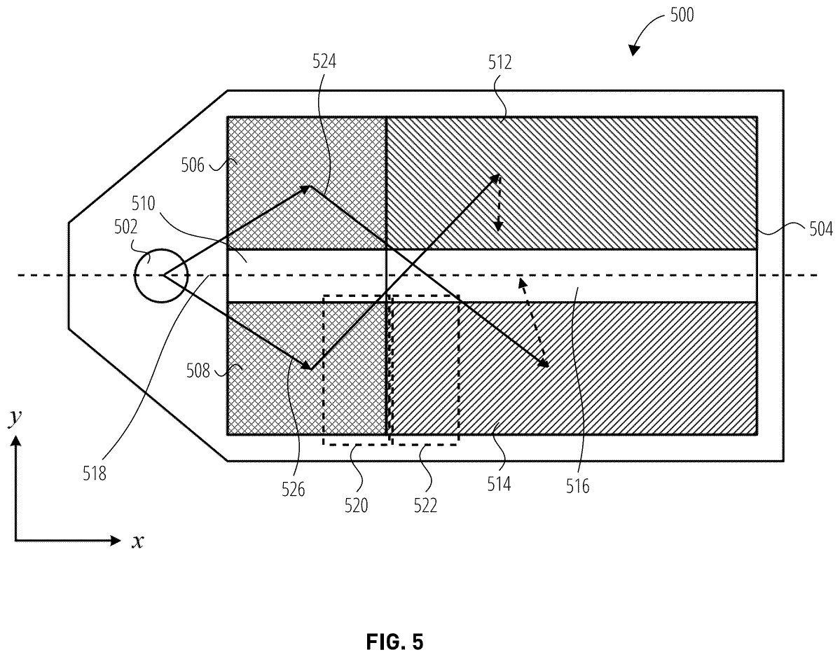

FIG. 5 shows a top view of a second example of multiple regions of a diffraction grating on a waveguide 500. The waveguide 500 has an input region, such as a diffraction grating shown as input grating 502, that couples light into the waveguide 500. The light then propagates within the waveguide 500 via TIR, generally travelling in the positive x direction, and travelling in the positive and negative y directions away from a centerline 518 extending from the center of the input grating 502 along the x dimension before being outcoupled from the waveguide 500 toward a viewer's eye.

The waveguide 500 also has an output grating 504 divided into multiple regions, each having different patterns, lattices, or gratings of diffractive structures. Left spreader region 506 and right spreader region 508 have diffractive structures configured to turn a portion of the light received from the input grating 502 in different directions generally along the y axis, to spread the light in the positive y direction (e.g., as shown by second light path 526 interacting with right spreader region 508 followed by left output region 512 before being outcoupled) and in the negative y direction (e.g., as shown by first light path 524 interacting with left spreader region 506 followed by right output region 514). Left output region 512 and right output region 514 include diffractive structures configured to outcouple at least a portion of the light from the waveguide 500. A central spreader region 510 include diffractive structures configured to diffract light away from the centerline 518 generally in the positive and negative y directions (and in the positive x direction) without outcoupling. Central outcoupling region 516 includes diffractive structures configured to outcouple at least a portion of the light from the waveguide 500 and to propagate remaining portions of the light in the positive x direction and also in the positive and negative y directions toward the left output region 512 and right output region 514.

The diffractive structures in each of the regions 506, 508, 510, 512, 514, and 516 may be different from each other and/or may be arranged in different patterns. The physical properties of the diffractive structures, including their placement within a pattern, can be selected or designed to perform functions specific to their respective regions. In some examples, the grating vectors and/or periodicity vectors of the various regions 506, 508, 510, 512, 514, and 516 may be the same as each other. In examples having some regions with one-dimensional (1D) gratings and some regions with two-dimensional (2D) gratings or lattices, the 1D components of the grating vectors may be the same across the 1D and 2D grating regions. A 1D grating, as referred to herein, is a diffraction grating having a structure that is periodic in a first direction in the plane of the grating but uniform in a second direction in the plane of the grating. In contrast, a 2D grating is periodic in two different directions in the plane of the grating.

In some examples, the boundaries between any two adjacent regions on the waveguide surface are visible due to the abrupt change in the optical properties of the diffractive structures of the two neighboring regions. Examples described herein can be used to mitigate or address one or both of these problems. For example, the abruptness of the change in reflectance or other visual qualities between the left spreader region 506 and left output region 512, or between right spreader region 508 and right output region 514, can be mitigated in some examples by modulating physical properties of the diffractive structures in one or more interstitial regions to provide a more smooth or continuous optical transition between regions.

In FIG. 5, two example interstitial regions are shown: a first interstitial region 520 and a second interstitial region 522 can each provide interstitial diffractive structures with intermediate values for one or more additional physical properties that lie between the values of the one or more properties in a first region (e.g., right spreader region 508) and a second region (e.g., right output region 514). In some cases, the interstitial regions are very small, and there may be a large number of interstitial regions positioned very close to the boundary between two regions; however, in this example the two interstitial regions 520 and 522 are shown as relatively large regions for clarity.

Thus, a waveguide described in these examples can comprise a first region (such as right spreader region 508), a second region (such as right output region 514), and at least one interstitial region (such as first interstitial region 520 and second interstitial region 522) located between the first and second regions. The first region has a plurality of first diffractive structures (e.g., a 2-dimensional lattice of notched diamond diffractive structures 200 for expansion of light in the x and y directions), each having a first value of a first physical property (e.g., a width of a gap between the diffractive structures 200) that gives rise to a first value of an optical property in the first region. The second region has a plurality of second diffractive structures (e.g., a 1-dimensional diffraction grating or a 2-dimensional lattice of stepped diffractive structures 300 for outcoupling of light from the waveguide 500), each having a second value of the first physical property (e.g., the width of the gap between the diffractive structures 300) that gives rise to a second value of the optical property in the second region. The at least one interstitial region has a plurality of interstitial diffractive structures: each interstitial diffractive structure has a value of at least one additional physical property different from the first physical property (e.g., the depth of the gap between diffractive structures). This value gives rise to an intermediate value of the optical property in the interstitial region, which is between the first and second values of the optical property. Thus, for example, an optical property such as outcoupling efficiency of a given diffractive order of the light can be modulated between a first value in the first region and a second value in the second region by using the depth of the gap as a proxy for the width of the gap. In this way, manufacturing challenges arising from very narrow gaps can potentially be avoided or mitigated by using gap depth instead of gap width as the modulated physical property within the interstitial regions.

FIG. 6 illustrates four different diffractive structures in four regions of a hypothetical waveguide and hypothetical transitions between these regions if unconstrained by manufacturability. The four diffractive structures of the four regions are shown as first diffractive structure 602, second diffractive structure 604, third diffractive structure 606, and fourth diffractive structure 608. The first diffractive structure 602 is a linear 1-dimensional diffraction grating line having a uniform height. The second diffractive structure 604 is a notched diamond having a uniform height, such as the diffractive structure 200 from FIG. 2, arranged in a 2-dimensional lattice with similar structures. The third diffractive structure 606 is a two-height stepped rectangular structure, such as the diffractive structure 300 from FIG. 3, arranged in a 2-dimensional lattice with similar structures. The fourth diffractive structure 608 is a two-height linear 1-dimensional diffraction grating line.

In the absence of manufacturing constraints, intermediate regions between the regions of these four structures could provide smoothly modulated values for various physical properties, providing a gradient of different diffractive structures representing various intermediate states between each pair of structures shown at the four corners of FIG. 6. Examples of such intermediate, unconstrained structures are shown as first intermediate diffractive structure 610, second intermediate diffractive structure 612, third intermediate diffractive structure 614, and fourth intermediate diffractive structure 616. The first intermediate diffractive structure 610 represents a halfway point or intermediate state between the first diffractive structure 602 and the second diffractive structure 604. The second intermediate diffractive structure 612 represents a halfway point or intermediate state between the second diffractive structure 604 and the third diffractive structure 606. The third intermediate diffractive structure 614 represents a halfway point or intermediate state between the third diffractive structure 606 and the fourth diffractive structure 608. The fourth intermediate diffractive structure 616 represents a halfway point or intermediate state between the fourth diffractive structure 608 and the first diffractive structure 602.

It will be appreciated that some of the transitions represented by the intermediate structures 610, 612, 614, and 616 may violate hard limits (e.g., physical capability limits) or soft limits (e.g., practical or resource-constrained limits) on manufacturability. For example, the narrow ridges of raised material 618 shown in second intermediate diffractive structure 612 and fourth intermediate diffractive structure 616 may be more difficult to manufacture than the wider ridges of raised material 618 shown in fourth diffractive structure 608, third intermediate diffractive structure 614, and third diffractive structure 606. Similarly, the narrow channels 620 shown in first intermediate diffractive structure 610 and third intermediate diffractive structure 614 may be more difficult to manufacture than the wider channels 620 shown in the other structures. The manufacturability of these raised ridges and channels becomes extremely difficult or impossible as their width approaches zero (e.g., as the structure transitions to a uniform-height structure, or the channel closes). Thus, to make manufacturing easier and to avoid discontinuities where a physical property (such as width) reaches a manufacturing minimum and is forced to jump to a zero value, examples described herein can select one or more additional physical properties to modulate as proxies for the physical properties shown being smoothly modulated in FIG. 6. Therefore, in some examples, the plurality of interstitial diffractive structures are easier to manufacture than a hypothetical plurality of diffractive structures having an intermediate value of the first physical property (e.g., raised ridge width or channel width) between the first and second values of the first physical property.

FIG. 7 shows a pair of graphs showing a non-manufacturable gradual change of gap widths replaced by a manufacturable change in gap depth. The unconstrained pattern 702, which presents manufacturing challenges, is shown above the constrained pattern 704, which respects manufacturing constraints to ease or improve manufacturability.

The unconstrained pattern 702 represents a gradual change in gap width between diffractive structures. This pattern may not be manufacturable due to limitations in fabrication processes, such as minimum etch width constraints. The graph shows a repeat unit number 706 of the lattice or grating on the horizontal axis and a height 708 (in nanometers) on the vertical axis. At the first unit 710, no channel is etched. However, beginning at the second unit 712, a channel begins to form, and it gradually widens until the final unit 714. These units represent different stages of the gradual change in gap width: each repeat unit number 706 can correspond to a distinct intermediate region of the grating or lattice along a grating direction (within the x-y plane of the waveguide or grating). Thus, the unconstrained pattern 702 shows a smooth modulation of a physical property (channel or gap width) from zero up to a maximum width shown at the final unit 714.

It will be appreciated that etching a deep and very narrow channel (such as the channel at the second unit 712) into a substrate, and then using that etched substrate to imprint a negative of the etched channel, presents difficult or even impossible manufacturing challenges. Accordingly, in some examples, the constrained pattern 704 may be applied instead to achieve a similar modulation or gradient of optical performance.

The constrained pattern 704 illustrates a manufacturable alternative to the unconstrained pattern 702. Instead of varying the gap width, which may violate manufacturing constraints, the constrained pattern 704 modulates the depth of the gap or channel between the diffractive structures.

The graph for the constrained pattern 704 also shows a repeat unit number 706 on the horizontal axis (indicating the repetition of a unit cell, and positioned at the boundary between two unit cell repetitions) and a height 708 on the vertical axis. As in the unconstrained pattern 702, there is no channel etched at the first unit 716. However, beginning at the second unit 718, a channel having at least a minimum manufacturable width is etched, at a shallow depth. The channel width remains the same but the depth increases until a maximum depth 720 is reached. After this point, the channel is etched to the maximum depth 720, but is widened, until a wide channel of the maximum depth 720 is etched at the final unit 722.

Thus, in the constrained pattern 704, the gap depth is modulated monotonically across one or more interstitial regions while maintaining a minimum gap width that satisfies manufacturing constraints. FIG. 7 thus demonstrates an example of using one or more unconstrained additional physical properties or parameters (e.g., channel depth) as a proxy for a first physical property or parameter (e.g., channel width) that is constrained in at least one of the intermediate regions. In this case, the gap depth serves as a proxy for gap width, allowing for a smooth transition in optical properties between different regions of the waveguide while respecting manufacturing limitations. In some examples, the smooth modulation may be monotonic over a portion of the distance between regions, followed by a non-monotonic change, followed by one or more additional monotonic portions.

In some examples, the gap depth modulation shown in the constrained pattern 704 can be combined with other physical property variations, such as changes in structure height, orientation, or coating thickness, to achieve the desired optical property transition between regions. The specific combination of physical properties may depend on the manufacturing process constraints and the desired optical properties of the waveguide. In some examples, a weighted average or other best-fit approximation of the desired optical properties is implemented to satisfy practical constraints.

In some examples, the additional physical property or physical properties used in an unconstrained pattern for the design of interstitial regions can include one or more of the properties described above, such as:
1. A depth of a channel between adjacent diffractive structures
2. A height of a first raised portion of the diffractive structures
3. A height of a second, third, or any further raised portion of the diffractive structures
4. A length of a channel between adjacent diffractive structures
5. An angle of a sidewall of the diffractive structures
6. A depth gradient of a sidewall of the diffractive structures
7. A blaze angle of a staircase structure of the diffractive structures
8. An orientation of the diffractive structures
9. A thickness of a coating on the diffractive structures
10. A refractive index of a coating on the diffractive structures

Various such physical properties, and techniques for their modulation, are described in greater detail below.

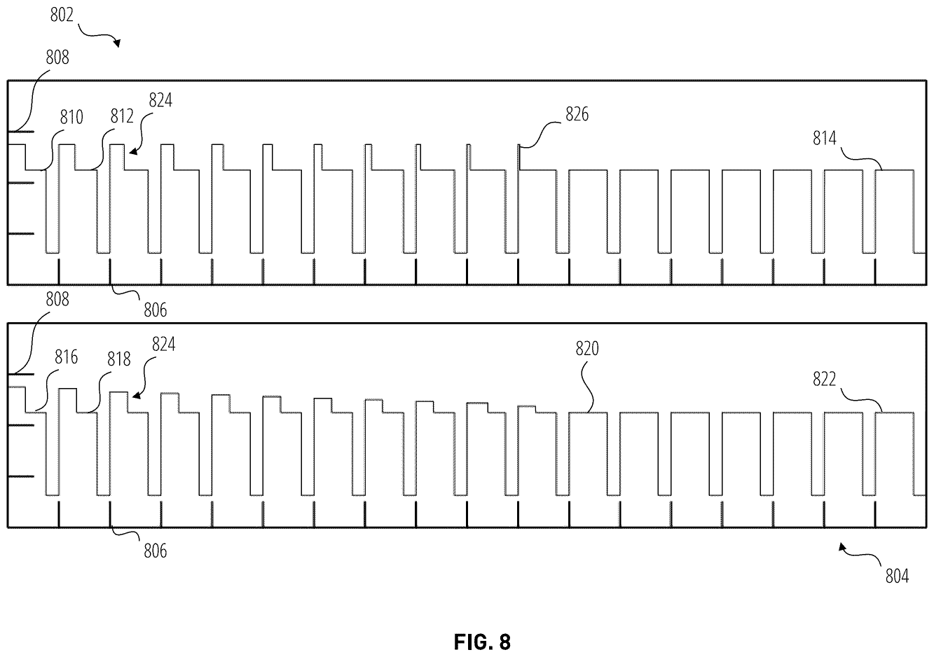

FIG. 8 shows another pair of graphs showing a non-manufacturable gradual change of the width of a raised portion of a structure replaced by a manufacturable change in the height of the raised portion of the structure. The unconstrained pattern 802, which presents manufacturing challenges, is shown above the constrained pattern 804, which respects manufacturing constraints to ease or improve manufacturability.

The unconstrained pattern 802 represents a gradual change in the width of a raised portion 824 of diffractive structures. The graph shows a repeat unit number 806 on the horizontal axis and a height 808 (in nanometers) on the vertical axis. At the first unit 810, the raised portion 824 of the structure is formed at its full maximum width. However, beginning at the second unit 712, the width of the raised portion 824 begins to decrease, eventually reaching a minimum width 826 before being omitted altogether as the unconstrained pattern 802 continues toward the final unit 814.

It will be appreciated that forming a tall and very narrow raised portion (such as the raised portion 824 at the minimum width 826) into a substrate through etching, and then using that etched substrate to imprint a negative of the raised portion, presents difficult or even impossible manufacturing challenge due to limitations on the aspect ratio (e.g., ratio of height to width) of raised structures. Accordingly, in some examples, the constrained pattern 804 may be applied instead to achieve a similar modulation or gradient of optical performance.

The constrained pattern 804 illustrates a manufacturable alternative to the unconstrained pattern 802. Instead of varying the width of the raised portion, which may violate manufacturing constraints, the constrained pattern 804 modulates the height of the raised portion of the diffractive structures.

The graph for the constrained pattern 804 also shows a repeat unit number 806 on the horizontal axis and a height 808 on the vertical axis. As in the unconstrained pattern 802, the raised portion 824 is formed at a maximum width at the first unit 816. In some examples, the maximum width of the raised portion 824 is a constant width corresponding to the minimum manufacturable width of the raised portion 824. Unlike in the unconstrained pattern 802, beginning at the second unit 818, the height (instead of the width) of the raised portion 824 is decreased. The width of the raised portion 824 remains the same but the height decreases until a minimum height 820 is reached. After this point, the raised portion 824 is omitted from the structure as the constrained pattern 804 proceeds to the final unit 822.

Thus, in the constrained pattern 804, the height of the raised portion 824 is modulated monotonically across one or more interstitial regions while maintaining a width of the raised portion 824 that satisfies manufacturing constraints. FIG. 8 thus demonstrates another example of using one or more unconstrained additional physical properties or parameters (e.g., height of the raised portion 824) as a proxy for a first physical property or parameter (e.g., width of the raised portion 824) that is constrained in at least one of the intermediate regions. In this case, the height of the raised portion 824 serves as a proxy for the width of the raised portion 824, allowing for a smooth transition in optical properties between different regions of the waveguide while respecting manufacturing limitations.

In some examples, the height modulation shown in the constrained pattern 804 can be combined with other physical property variations, such as changes in the height of other portions of the structure, changes in orientation, or changes in coating thickness, to achieve the desired optical property transition between regions. The specific combination of physical properties may depend on the manufacturing process constraints and the desired optical properties of the waveguide. The additional physical properties used to achieve this modulation can include one or more of those described above.

In some examples, the approach shown in the constrained pattern 804 allows for transitioning from an n-level structure to an (n+1)-level structure (or vice versa) by smoothly modulating the height of the top step from a maximum value in the first region to a zero value in the second region (or vice versa). In general, any of the transitions described herein will be understood to be applicable in any direction.

In some examples, as shown in the examples of FIG. 7 and FIG. 8, the additional physical property or properties of the interstitial diffractive structures can be modulated linearly along a spatial dimension (such as the x axis of the waveguide plane), or along a path within the plane of the waveguide. However, in some examples, a non-linear but monotonic modulation of the additional physical property or properties of the interstitial diffractive structures can be used to provide a desired gradient for the desired optical property along a dimension or path within the plane of the waveguide.

FIG. 9A illustrates a side cross-sectional view of a blazed diffractive structure 902 showing a sidewall angle 908 and a blaze angle 916 of the structure. Because of manufacturing constraints, a staircase structure 900 as shown in FIG. 9B may be used to approximate the optical effects of the blazed diffractive structure 902.

FIG. 9B illustrates a side cross-sectional view of a multi-height stepped diffractive structure, staircase structure 900, showing a sidewall angle 908 and a pseudo-blaze angle 904 of the staircase structure 900. A channel 906 separates adjacent diffractive elements. In some examples, the staircase structure 900 is a 1-dimensional linear grating line shown in cross-section.

The pseudo-blaze angle 904, measuring an angle at which the stepped face (in this example, the left face) of the staircase structure 900 ascends from the bottom of a channel 906 to the top of the staircase structure 900, approximates the optical effect of a continuous blazed surface at the same angle. This pseudo-blaze angle 904 is formed by the stepped nature of the structure, allowing for the manipulation of diffraction efficiencies in a manner similar to a true blazed surface. The pseudo-blaze angle 904 may be adjusted to optimize the distribution of light into desired diffraction orders.

The depth and width of the channel 906 may be modulated in some examples to achieve specific optical properties while observing manufacturability constraints.

The staircase structure 900 features a sidewall (in this case, the right face) having a sidewall angle 908 relative to the horizontal bottom of the channel 906. The sidewall angle 908 represents the angle at which the sidewall extends upward to ward the top of the staircase structure 900 from the bottom of the channel 906. The sidewall angle 908 may be approximately 90 degrees in some examples; in other examples, manufacturing constraints and/or optical design considerations may result in a sidewall angle 908 of less than 90 degrees, or a sidewall angle 908 of more than 90 degrees resulting in an undercut or overhang.

This sidewall angle 908 may be varied as one of the additional physical properties to achieve desired optical characteristics in interstitial regions between different diffractive structures. The sidewall angle 908 may be uniform across all steps or may vary between steps to further fine-tune the diffractive properties.

The staircase structure 900 comprises multiple steps or raised portions, including a first raised portion 910, a second raised portion 912, and a third raised portion 914. These raised portions form the steps of the staircase structure, with each step contributing to the overall diffractive effect. The heights of these raised portions may be individually modulated to create a smooth transition between different regions of a waveguide with distinct diffractive properties.

In some examples, the heights of the raised portions 910, 912, and 914 can be adjusted to compensate for limitations in other physical properties, such as minimum feature size or maximum aspect ratio. This approach allows for effects such as the height of a top step being reduced to facilitate a transition from a three-level structure to a two-level structure while maintaining manufacturability.

The staircase structure 900 may be part of a larger diffractive optical element (DOE) on a waveguide surface. Multiple such structures may be arranged in a pattern to form a diffraction grating, with the specific arrangement and dimensions of the structures determining the overall optical properties of the grating.

In the context of a waveguide design with multiple regions, the staircase structure 900 may represent an interstitial diffractive structure located between regions with different diffractive properties. By modulating the pseudo-blaze angle 904, sidewall angle 908, and/or the heights of the raised portions 910, 912, and 914, the staircase structure 900 can achieve intermediate values of desired optical properties, facilitating a smooth transition between regions while respecting manufacturing constraints.

The staircase structure 900 may be fabricated using multi-step lithographic processes, with each step corresponding to a different raised portion. The specific fabrication technique may influence the achievable sidewall angles, step heights, and/or overall structure geometry. In some examples, the staircase structure 900 may be formed by etching a master template and then using imprint lithography to transfer the pattern onto a waveguide surface.

Thus, a blaze or pseudo-blaze angle is an example of a physical property of a diffractive structure that can be varied between regions to modulate an optical property. Diffractive structures with blazed or sloped sidewalls can modulate the angle of the blazed sidewall in order to modulate the ratio of light diffracting in positive diffraction orders relative to negative diffraction orders. Thus, light incident on a diffraction grating can be steered in a desired direction by modulating the blaze angle of the grating structures. In some examples, the blaze angle of the structures can be modulated using multi-height structures (such as diffractive structure 300) having staircase-like profiles in which the steps of the staircase have modulated x-y dimensions, thereby forming a pseudo-blazed stepped sidewall of varying angle. In some examples, the blaze angle can be modulated continuously without using a pseudo-blaze using other manufacturing techniques, such as angled etching and/or angled deposition of materials.

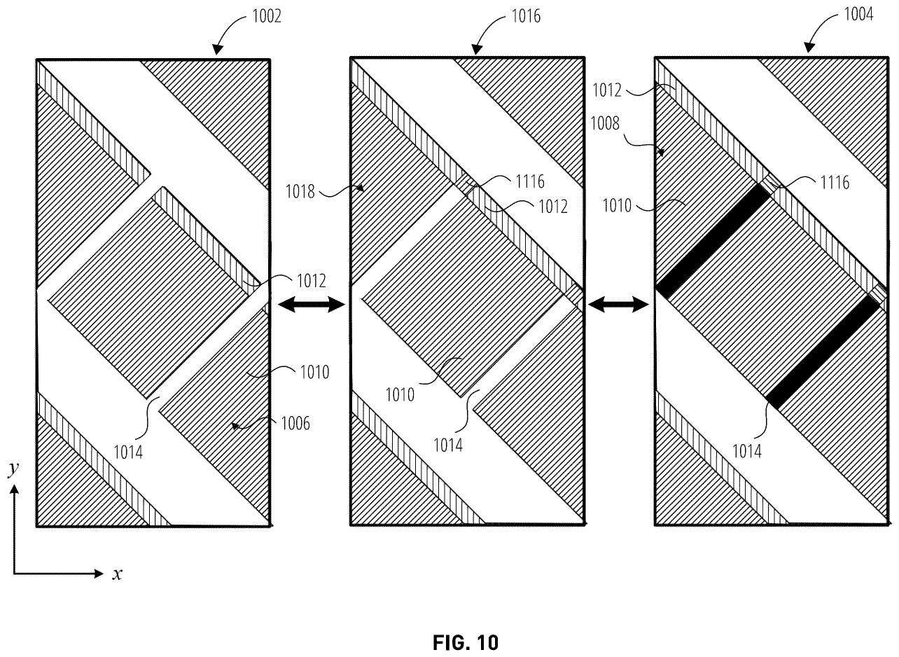

FIG. 10 illustrates a top view of a multi-height diffractive structure varied between two regions to have different depths of a narrow depression to join structures into grating lines. The figure depicts a first region 1002, a second region 1004, and an interstitial region 1016 located between the first and second regions.

The first region 1002 contains a first multi-height structure 1006, consisting of a first raised portion 1010 and a higher second raised portion 1012. These raised portions form part of a diffractive structure, potentially contributing to the overall optical properties of the region. Each first multi-height structure 1006 is separated from adjacent structures by a narrow depression 1014 defining a channel, which can influence the diffractive characteristics of the structure. Thus, the first multi-height structures 1006 in the first region 1002 are divided from each other by channels extending along two dimensions, thereby forming a 2-dimensional lattice.

The second region 1004 contains a second multi-height structure 1008, which also consists of a first raised portion 1010 and a higher second raised portion 1012. The heights of the first raised portion 1010 and second raised portion 1012 are the same as those in the first multi-height structure 1006 of the first region 1002.

The second multi-height structure 1008 differs from the first multi-height structure 1006 in the depth of its narrow depression 1014, which does not extend down to the depth of the channels. Instead, the narrow depression 1014 cuts through only a portion of the height of the second multi-height structure 1008, defining a narrow depressed portion of the first raised portion 1010 and a narrow depressed portion of the second raised portion 1012 (shown as raised channel portion 1116). This variation in depression depth between the first region 1002 and second region 1004 may result in different optical properties, such as diffraction efficiency or angular distribution of diffracted light. In effect, the second multi-height structure 1008 operates more like a 1-dimensional linear diffraction grating line defining a diffraction grating in the second region 1004 in contrast to the 2-dimensional lattice defined in the first region 1002.

To smoothly transition between the optical properties of the first multi-height structure 1006 of the first region 1002 and the second multi-height structure 1008 of the second region 1004, an interstitial region 1016 is provided that contains an array of interstitial multi-height structures 1018. These interstitial multi-height structures 1018 serve as a transition between the structures in the first and second regions.

The interstitial multi-height structure 1018 features one or more intermediate values of the depth of the narrow depression 1014, providing a smooth transition in optical properties between the first region 1002 and second region 1004. Because the narrow depression 1014 in the first region 1002 is already narrow, any attempt to further narrow the narrow depression 1014 to achieve a linear grating may present manufacturing challenges. Instead, the narrow depression 1014 can be decreased in etch depth in the interstitial region 1016: in this example, the narrow depression 1014 in the interstitial multi-height structure 1018 defines a first portion through the first raised portion 1010 that is at the same depth (or height) as the channels of the first multi-height structure 1006, as well as a second portion (raised channel portion 1116) through the second raised portion 1012 that is the same height as the first raised portion 1010. However, it will be appreciated that these intermediate values for the heights or depths of the narrow depression 1014 are provided merely as examples.

As in the other described examples, the multi-height depression depth modulation approach allows for the creation of interstitial diffractive structures with intermediate values of desired optical properties, facilitating a smooth transition between regions while respecting manufacturing constraints. By modulating the depth of the narrow depression 1014, possibly along with other physical parameters such as the dimensions of the raised portions 1010 and 1012, waveguide designers can create complex optical elements that efficiently manipulate light propagation while maintaining feasibility for large-scale production.

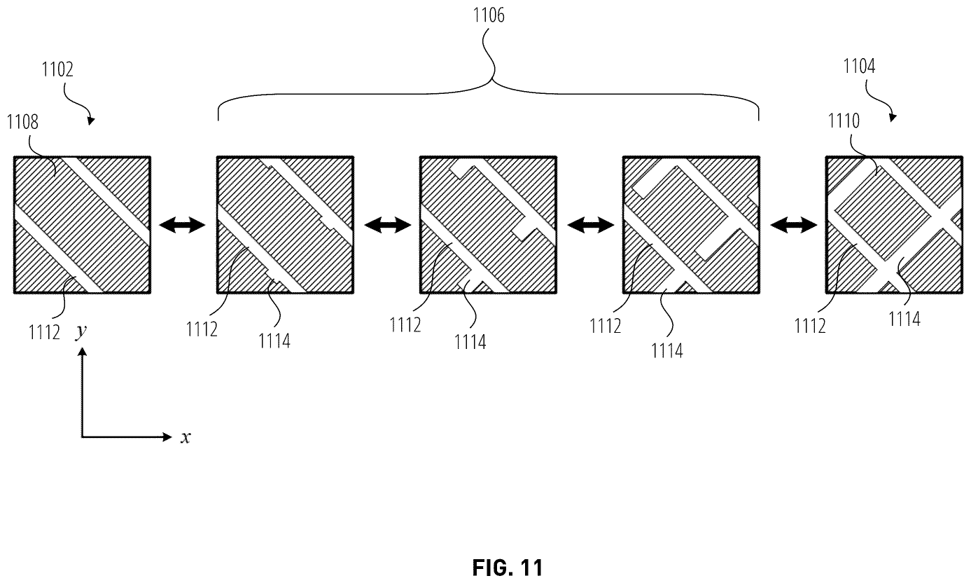

FIG. 11 illustrates a top view of a multi-height diffractive structure varied between two regions to have different lengths of channels to separate 1D grating lines into discrete structures of a 2D lattice. The figure depicts a first region 1102, a second region 1104, and three example interstitial regions 1106 located between the first and second regions.

The first region 1102 includes diffractive structures in the form of grating lines 1108, which are arranged, separated by parallel channels 1112, to form a one-dimensional (1D) diffraction grating. The diffraction grating formed by the grating lines 1108 can be geometrically and materially configured to diffract light into one or more diffraction orders to impart a single grating vector to the diffracted light.

The second region 1104 includes a 2D lattice pattern of 2D lattice structures 1110, separated from each other in a first direction by the parallel channels 1112 and in a second direction by perpendicular channels 1114. This 2D lattice structure 1110 may offer different optical properties compared to the 1D grating lines 1108 of first region 1002, such as the ability to diffract light in multiple directions or provide more complex wavefront shaping.

The transition between the 1D grating line 1108 and the 2D lattice structure 1110, such that there is a smooth gradient of one or more desired optical properties, is facilitated by the interstitial regions 1106. These regions contain structures that gradually transform from the 1D configuration to the 2D configuration, providing a smooth transition in optical properties between the two distinct regions.

The transformation from 1D to 2D structures is achieved through the modulation of channel lengths. As in the unconstrained pattern 702 of FIG. 7, smooth modulation of channel width to or from a zero value may be impossible or difficult due to manufacturing limitations. However, unlike the example constrained pattern 704 of FIG. 7 or the approach shown in FIG. 10, which use channel depth as a proxy for channel width, the approach shown in FIG. 11 uses channel length as the additional physical property being modulated. Instead of gradually widening the perpendicular channels 1114 starting from zero width in the first region 1102, the perpendicular channels 1114 are instead etched at a fixed width and to a fixed depth, but are initially etched as very short channels extending outward from the parallel channels 1112, and are gradually lengthened until they merge into continuous channels in the second region 1104.

Thus, the perpendicular channels 1114 are introduced in the interstitial regions 1106 and gradually lengthened to separate each continuous grating line 1108 into discrete 2D lattice structures 1110. This approach allows for a controlled transition in optical diffractive properties while maintaining manufacturability. The gradual introduction and lengthening of these perpendicular channels 1114 allow for a smooth transition in optical properties between the two regions. In some examples, the perpendicular channels 1114 can extend in one direction, as shown in FIG. 11 (where they gradually extend from top left toward bottom right); in other examples, the perpendicular channels 1114 can gradually extend in both of two opposite directions (e.g., from top-left toward bottom-right and also from bottom-right toward top-left).

In some examples, the channel length modulation may be combined with other parameter variations, such as changes in structure height, channel depth, or any one or more of the other physical properties described above, to achieve the desired optical property transition between regions. The specific combination of parameters may depend on the manufacturing process constraints and the desired optical properties of the waveguide.

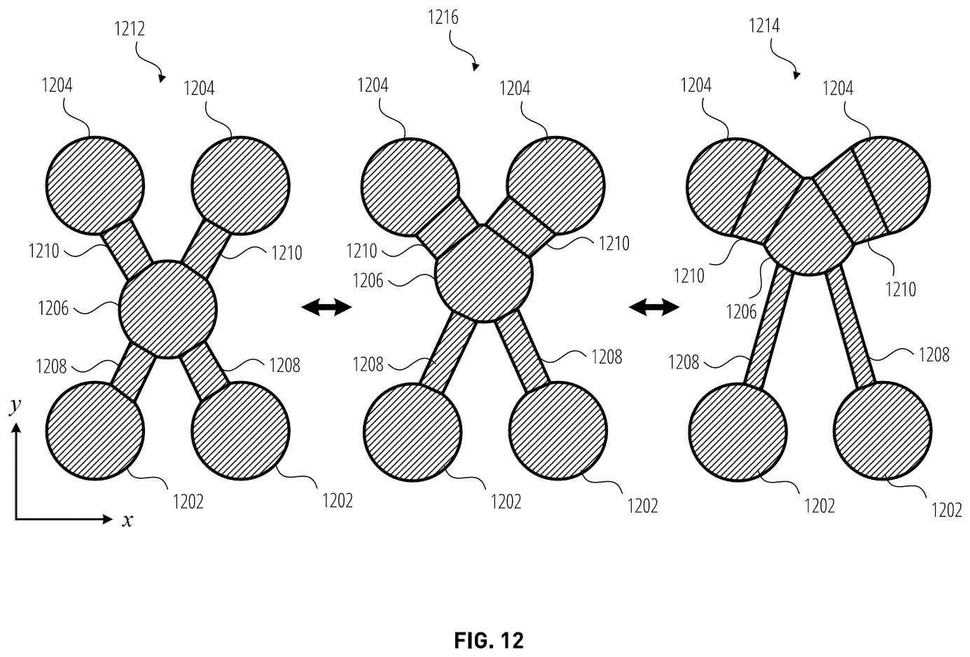

FIG. 12 illustrates a top view of a unit cell of a diffractive lattice showing five diffractive structures joined by diagonal blend bridges. In different examples, the diffractive structures can be any suitable diffractive structures, such as diffractive structures 200, diffractive structures 300, or any of the other diffractive structures described herein. The five diffractive structures include two bottom islands 1202, two top islands 1204, and a central island 1206. The diagonal blend bridges include two bottom bridges 1208 joining the central island 1206 to each of the bottom islands 1202, and two top bridges 1210 joining the central island 1206 to each of the top islands 1204. In the context of FIG. 12, the terms “top” and “bottom” refer to the orientation of the drawing, which is a top view within the x-y (horizontal) plane of the waveguide, such that “top” refer to the positive y direction and “bottom” refers to the negative y direction.

The unit cell represents a fundamental repeating element of a diffractive structure within a waveguide. This particular configuration demonstrates a method for creating smooth transitions between different regions of a DOE while maintaining manufacturability. It will be appreciated that, whereas a single unit cell is shown having bridges joining five islands of material within the unit cell, in some examples the peripheral islands (top islands 1204 and bottom islands 1202) of the unit cell can also be connected to peripheral islands in adjacent unit cells by additional bridges, thereby forming a network of bridges joining together a 2D array of islands. In some examples, these bridges joining unit cells can also be modulated according to the techniques described below.

The bottom islands 1202 and top islands 1204 are discrete diffractive structures positioned at opposite corners of the unit cell. These islands may have specific geometries and dimensions designed to achieve desired optical properties, such as diffraction efficiency or angular distribution of diffracted light.

The central island 1206 is positioned in the middle of the unit cell. This central structure may serve to modulate the overall diffractive properties of the unit cell and provide additional control over the optical characteristics of the lattice. In the illustrated example, the location of the central island 1206 within the unit cell changes between the first region 1212 and the second region 1214. This movement of the central island between different regions of the DOE may serve various functions, such as spatial modulation of optical properties of the DOE to mitigate phase interference effects giving rise to nonuniformities in the light outcoupled from the waveguide.

The bottom bridge 1208 and top bridge 1210 are diagonal structures that connect the islands. These blend bridges represent a further approach to creating smooth transitions between different diffractive structures or regions within a waveguide. The bridges allow for gradual changes in structure geometry while maintaining connectivity between discrete elements. This can eliminate discontinuities in optical properties when transitioning between a region having discrete 2D lattice diffractive structures and a region having continuous linear 1D grating diffractive structures. The use of blend bridges can also address the problem of manufacturability of small gap widths as diffractive structures approach each other.

The blend bridges 1208 and 1210 provide permanent narrow bridges that link islands of material and change orientation, shape, width, length, and height as required by the positions of the island structures within a unit cell and the desired optical properties in a given interstitial region. This approach enables the creation of interstitial diffractive structures with intermediate values of desired optical properties, facilitating a smooth transition between regions while respecting manufacturing constraints.

As shown in FIG. 12, the blend bridges are included in both the first region 1212 and the second region 1214, as well as any interstitial regions 1216. Thus, in some examples described herein, the design of the first region and second region may be reconfigured to enable a smooth transition in optical properties, in addition to configuring one or more interstitial regions.

In the first region 1212, the central island 1206 is located in the center of the unit cell, and the top bridges 1210 and bottom bridges 1208 are symmetrical, having equal lengths and widths. The heights and widths of the top bridges 1210 and bottom bridges 1208 can be any height suitable to achieve the desired optical properties of the first region 1212: for example, the bridges may have a height equal to the islands, or equal to have the height of the islands, or any other height. In the examples described below, the bridges are assumed to have a height equal to half the height of the islands in the first region 1212.

In the second region 1214, the central island 1206 has migrated in the positive y direction within the unit cell to come into contact or near contact with the top islands 1204. In some cases, the islands may move toward each other sufficiently that they overlap and thereby merge, at least in part. It will be appreciated that various examples may move one or more islands in arbitrary directions within the unit cell; the concept of blend bridges is equally applicable to any such movements of diffractive structures relative to each other.

In the second region 1214, the top bridges 1210 address the proximity of the top islands 1204 to the central island 1206 by filling in the narrow interstices between the islands. Thus, the dimensions of the top bridges 1210 in the second region 1214 are significantly different from those of the top bridges 1210 in the first region 1212. In the second region 1214, the top bridges 1210 are shorter and wider, and they merge with the islands over a wider arc or portion of the islands' peripheries. The top bridges 1210 can also be elevated relative to their height in the 1212: for example, if the top bridges 1210 are half the height of the islands in the first region 1212, in the second region 1214 they can be formed at or near the height of the islands, such that the top islands 1204 and the central island 1206 begin to merge together into a single continuous and uniform-height structure including the top bridges 1210.

Conversely, the bottom bridges 1208 in the second region 1214 are longer and thinner than they are in the first region 1212, due to the movement of the central island 1206 away from the bottom islands 1202. In some examples, the bottom bridges 1208 are also lower in height in the second region 1214 than they are in the first region 1212. For example, if the bottom bridges 1208 are half the height of the islands in the first region 1212, they may be a quarter of the height of the islands in the second region 1214, or some other suitable height.

Thus, in some examples, the problem of non-manufacturable narrow channel widths as diffractive structures approach each other can be addressed by inserting a bridge across the channel, and varying the dimensions of the bridge based on the relative positions of the diffractive structures. In this example, the physical property initially identified as giving rise to the desired optical property is the channel width, and the one or more additional physical properties used as a proxy to modulate the desired optical property are the dimensions of the bridge joining the adjacent diffractive structures across the channel.

The use of blend bridges in this configuration allows for complex transitions between different diffractive structures, such as transitioning from a two-dimensional (2D) lattice to a one-dimensional (1D) grating structure, and vice versa. By gradually modifying the geometric and/or material properties of the blend bridges and/or island structures across multiple regions, waveguide designers can create smooth transitions that minimize unwanted optical effects such as visible boundaries or reduced display performance.

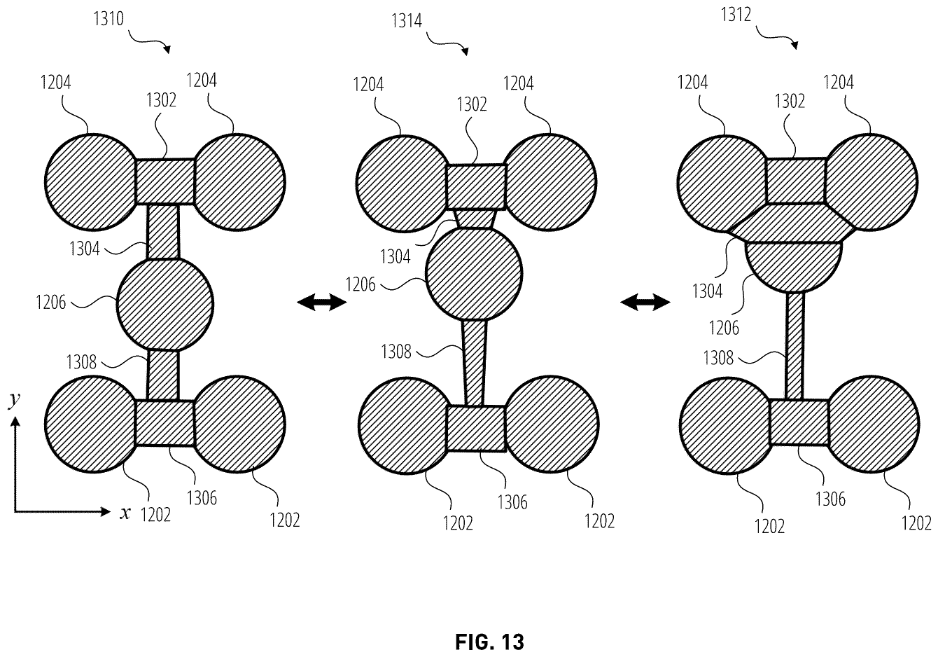

FIG. 13 illustrates a top view of a unit cell of a diffractive lattice showing five diffractive structures joined by H-shaped blend bridges. The blend bridges used in FIG. 13 differ from the diagonal blend bridges of FIG. 12 with respect to the orientation and arrangement of the bridges. In FIG. 13, the H-shaped blend bridges include a top cross bridge 1302 joining the two top islands 1204, a top central bridge 1304 joining the top cross bridge 1302 to the central island 1206, a bottom cross bridge 1306 joining the two bottom islands 1202, and a bottom central bridge 1308 joining the bottom cross bridge 1306 to the central island 1206. Thus, the arrangement of the blend bridges form an “H” shape if turned 90 degrees from the configuration shown in the drawing. As in the example of FIG. 12, the unit cells may also be joined by bridges in some examples, and these bridges may also be modulated as described herein.

In this example using H-shaped blend bridges, the central bridges 1304 and 1308 are the primary structures being varied as the central island 1206 migrates toward the top islands 1204: the top central bridge 1304 gets shorter and wider, and the bottom central bridge 1308 gets longer and thinner. Whereas the cross bridges 1302 and 1306 are shown having constant dimensions in FIG. 13, in some cases these bridges may also change their dimensions. For example, the height of the cross bridges may change along with the heights of the central bridges. In some examples, the top central bridge 1304 rises in height in the interstitial regions 1314 between the first region 1310 and the second region 1312, whereas the bottom central bridge 1308 lowers in height between the second first region 1310 and the second region 1312, as with the diagonal bridges of FIG. 12. In some examples, the cross bridges maintain a constant height in each region (e.g., the same height as the islands), whereas in some examples the cross bridges also change height: for example, the cross bridges may have a first height in the first region 1310 (such as the same height as the islands, or 75% of the height of the islands), but in the second region 1312 the top cross bridge 1302 may have a greater height than in first region 1310 (such as rising from 75% to 100% of the height of the islands) and/or the bottom cross bridge 1306 may have a lower height than in the first region 1310 (such as falling from 100% or 75% of the height of the islands to 50% of 25% of the height of the islands).

It will be appreciated that other configurations of blend bridges are possible other than the examples shown in FIG. 12 and FIG. 13. The use of blend bridges provides a set of continuous linkages between diffractive structures that can increase or decrease in prominence as the distance between the structures decreases or increases, thereby potentially addressing discontinuities in optical properties and potentially addressing manufacturability constraints.

FIG. 14 shows an example method 1400 for manufacturing a waveguide. In various examples, method 1400 can be used to manufacture a waveguide that addresses one or more of the technical challenges or problems identified above by modulating one or more additional physical properties in one or more interstitial regions between a first region and a second region, where modulating the additional physical properties results in greater ease of manufacture of the waveguide than smoothly modulating a first physical property giving rise to a desired optical property.

Although the example method 1400 depicts a particular sequence of operations, the sequence may be altered without departing from the scope of the present disclosure. For example, some of the operations depicted may be performed in parallel or in a different sequence that does not materially affect the function of the method 1400. In other examples, different components of an example device or system that implements the method 1400 may perform functions at substantially the same time or in a specific sequence.

According to some examples, the method 1400 includes obtaining a desired optical property to be varied between a first region and a second region at operation 1402. The desired optical property may be any optical property considered in DWC design, and can potentially include a wide range of characteristics that influence light propagation and manipulation within the waveguide. These properties may include the optical efficiencies of various diffracted, reflected, and/or transmitted orders of light as they interact with structures within, or on a surface of, the waveguide. Additionally, the desired optical property may extend to factors such as the angular distribution of diffracted light, the uniformity of color and brightness across the waveguide surface, and the overall image quality and resolution produced by the DWC.

According to some examples, the method 1400 includes determining a first physical property of diffractive structures that can be varied to modulate the desired optical property at operation 1404. Examples of first physical properties described above are the width of a gap or channel between adjacent diffractive structures, and the width of a raised portion of a diffractive structure. However, it will be appreciated that any physical property of a waveguide can potentially be identified as the most straightforward or obvious parameter to vary in order to achieve a given value for an optical property, including any of the physical properties described herein.

According to some examples, the method 1400 includes determining additional physical properties of diffractive structures that can be more easily varied to modulate the desired optical property at operation 1406. If smoothly varying the first physical property between the first region and the second region presents difficulties for manufacturability, a designer (or an automated, computer-implemented algorithm or machine learning model) can instead identify an additional physical property, or a combination of two or more additional physical properties, that can be varied as a proxy for the first physical property. Examples described above include using channel depth (FIG. 7 or FIG. 10) or channel length (FIG. 11) as a proxy for channel width, and using structure height (FIG. 8) as a proxy for structure width. However, it will be appreciated that any one or more of the physical properties described above can be used as a proxy for the first physical property to modulate the desired optical property or properties.

According to some examples, the method 1400 includes generating a waveguide design having one or more interstitial regions between the first and second regions having interstitial diffractive structures with values of the at least one additional physical property giving rise to intermediate values of the optical property at operation 1408.

In some examples, the design of the interstitial regions of the waveguide can be guided by further considerations. It may not always be possible to prescribe that all relevant diffraction orders under all conditions will undergo a smooth monotonic transition between the first and second regions. In order to mitigate other unwanted changes to the behavior of the diffraction gratings, method 1400 may include the further modification of the physical properties of the structures based on an objective function, such as a loss function that is minimized when balancing different physical changes against each other. The loss function could be minimized to mitigate unwanted differences between the first and second regions while respecting manufacturing constraints. In some examples, the loss function could be a weighted sum of square of the unwanted differences in optical properties of the regions, or another suitable measure of unwanted optical property changes as a result of the physical changes determined at operation 1406 and/or operation 1408.

In some examples, the method 1400 can also include manufacturing the waveguide based on the design generated at operation 1408. Because the one or more additional physical properties can be smoothly varied without violating manufacturing constraints, the design generated at operation 1408 should be easier to manufacture than a design in which the first physical property is smoothly varied between the value in the first region and the value in the second region.

In some examples, the method 1400 can be implemented by a machine, such as a computer with one or more processors executing instructions stored in a memory or other non-transitory computer-readable storage medium. The method 1400 can be implemented by waveguide design software, such as electronic design automation (EDA) software. In some examples, the manufacture of the waveguide can be performed by one or more machines, such as a lithography and etching device, followed by a material deposition and imprinting device. It will be appreciated that the various operations of method 1400 and other techniques described herein can be performed by one or more machines, with varying degrees of human interaction.

### CONCLUSION

Examples described herein may address one or more technical problems associated with diffractive waveguide design and manufacturing.

One potential benefit of the described examples is the improvement of the cosmetic appearance of the DWC device. This can be achieved by reducing visual artifacts on the DWC surface, such as artifacts at region boundaries, which can be observed in modeling by analyzing the reflection diffraction orders from the surface.

To test the effectiveness of the described approach, simulations have been performed to compare three cases:
1. Interpolation of a first physical property (e.g., channel width) across interstitial regions, ignoring fabrication limits.
2. Interpolation of the first physical property (e.g., channel width), respecting a channel width fabrication restriction.
3. Interpolation respecting fabrication restrictions as in case (2), with the inclusion of blend bridges.

The simulations show that introducing the channel width fabrication limit in case (2) creates a sharp boundary between 1D and 2D structures. However, when modifying the boundary with a blend bridge in case (3), the visibility of the boundary is reduced and becomes comparable to the completely smooth interpolation case (1).

Another potential benefit of the described examples is improved preservation of propagating wavefront quality in the DWC for ray paths that cross boundaries between regions containing distinct structures. Efficient DWC designs often require multiple regions within each DOE to exhibit different diffractive properties. This results in step changes in diffractive structure parameters across the surface, leading to unwanted optical effects such as visible boundaries to outside observers and reduced system resolution. Examples described herein may address this problem by providing interstitial diffractive structures between regions of distinct diffractive structures. These intermediate structures are created using a blend of geometric parameters such as duty cycle, orientation, height, and coating thickness. By implementing a smooth transition between different regions, this approach aims to not only minimize the visibility of boundaries but also to preserve the wavefront quality for ray paths crossing these boundaries.

A further potential benefit is to improve manufacturability of DWCs. A completely smooth geometric blend between two or more distinct structures is often limited by constraints within a given manufacturing process, such as minimum channel width, minimum structure size, and maximum structure aspect ratio. Examples described herein may address this problem by modifying the blending process to respect manufacturing constraints. When a parameter would violate a constraint, it is compensated by the modification of another parameter. This approach allows for the creation of intermediate structures that maintain the desired optical properties while remaining within manufacturing limitations.

A further potential benefit is to improve continuity of optical parameters from one region to another. In some cases, transitioning between distinct diffractive structures requires changes in multiple parameters simultaneously, which can be challenging to implement while maintaining desired optical properties. Examples described herein may address this problem by providing a combination of blending techniques to address complex transitions.

Specific examples are now described.

Example 1 is a waveguide, comprising: a first region comprising a plurality of first diffractive structures, each first diffractive structure having a first value of a first physical property giving rise to a first value of an optical property in the first region; a second region comprising a plurality of second diffractive structures, each second diffractive structure having a second value of the first physical property giving rise to a second value of the optical property in the second region; and at least one interstitial region located between the first region and the second region, the at least one interstitial region comprising a plurality of interstitial diffractive structures, each interstitial diffractive structure having a value of at least one additional physical property different from the first physical property, the value of the at least one additional physical property giving rise to an intermediate value of the optical property in the at least one interstitial region, the intermediate value being between the first value and the second value of the optical property.

In Example 2, the subject matter of Example 1 includes, wherein: the plurality of interstitial diffractive structures having the value of the at least one additional physical property is more manufacturable than a hypothetical plurality of diffractive structures having an intermediate value of the first physical property between the first value and the second value of the first physical property.

In Example 3, the subject matter of Examples 1-2 includes, wherein: the first physical property comprises a width of a channel between adjacent diffractive structures.

In Example 4, the subject matter of Example 3 includes, wherein: the at least one additional physical property comprises a depth of the channel.

In Example 5, the subject matter of Examples 3-4 includes, wherein: the at least one additional physical property comprises dimensions of a bridge joining the adjacent diffractive structures across the channel.

In Example 6, the subject matter of Examples 1-5 includes, wherein: the first physical property comprises a width of a raised portion of the diffractive structures.

In Example 7, the subject matter of Example 6 includes, wherein: the at least one additional physical property comprises a height of the raised portion of the diffractive structures.

In Example 8, the subject matter of Examples 1-7 includes, wherein: the at least one additional physical property comprises at least one of: a depth of a channel between adjacent diffractive structures; a height of a first raised portion of the diffractive structures; a height of a second raised portion of the diffractive structures; a length of a channel between adjacent diffractive structures; an angle of a sidewall of the diffractive structures; a depth profile of a sidewall of the diffractive structures; a blaze angle of a staircase structure of the diffractive structures; an orientation of the diffractive structures; a thickness of a coating on the diffractive structures; or a refractive index of a coating on the diffractive structures.

In Example 9, the subject matter of Example 8 includes, wherein: the at least one additional physical property comprises at least two of: a depth of a channel between adjacent diffractive structures; a height of a first raised portion of the diffractive structures; a height of a second raised portion of the diffractive structures; a length of a channel between adjacent diffractive structures; an angle of a sidewall of the diffractive structures; a depth profile of a sidewall of the diffractive structures; a blaze angle of a staircase structure of the diffractive structures; an orientation of the diffractive structures; a thickness of a coating on the diffractive structures; or a refractive index of a coating on the diffractive structures.

In Example 10, the subject matter of Examples 1-9 includes, wherein: the at least one interstitial region comprises a plurality of interstitial regions arranged between the first region and the second region such that the respective plurality of intermediate values of the optical property vary smoothly and monotonically between the first region and the second region.

Example 11 is a method, comprising: obtaining a desired optical property of a waveguide to be varied between a first region and a second region of the waveguide; determining a first physical property of diffractive structures that can be varied to modulate the desired optical property; determining at least one additional physical property of the diffractive structures that can be varied to modulate of the desired optical property, the diffractive structures being more manufacturable with variation of the at least one additional physical property than variation of the first physical property; and generating a design for the waveguide comprising at least one interstitial region located between the first region and the second region, the at least one interstitial region comprising a plurality of interstitial diffractive structures, each interstitial diffractive structure having a value of the at least one additional physical property, the value of the at least one additional physical property giving rise to an intermediate value of the optical property in the at least one interstitial region, the intermediate value being between a first value of the optical property in the first region and a second value of the optical property in the second region.

In Example 12, the subject matter of Example 11 includes, wherein: the first physical property comprises a width of a channel between adjacent diffractive structures.

In Example 13, the subject matter of Example 12 includes, wherein: the at least one additional physical property comprises a depth of the channel.

In Example 14, the subject matter of Examples 12-13 includes, wherein: the at least one additional physical property comprises dimensions of a bridge joining the adjacent diffractive structures across the channel.

In Example 15, the subject matter of Examples 11-14 includes, wherein: the first physical property comprises a width of a raised portion of the diffractive structures.

In Example 16, the subject matter of Example 15 includes, wherein: the at least one additional physical property comprises a height of the raised portion of the diffractive structures.

In Example 17, the subject matter of Examples 11-16 includes, wherein: the at least one additional physical property comprises at least two of: a depth of a channel between adjacent diffractive structures; a height of a first raised portion of the diffractive structures; a height of a second raised portion of the diffractive structures; a length of a channel between adjacent diffractive structures; an angle of a sidewall of the diffractive structures; a depth profile of a sidewall of the diffractive structures; a blaze angle of a staircase structure of the diffractive structures; an orientation of the diffractive structures; a thickness of a coating on the diffractive structures; or a refractive index of a coating on the diffractive structures.

In Example 18, the subject matter of Examples 11-17 includes, wherein: the at least one interstitial region comprises a plurality of interstitial regions arranged between the first region and the second region such that the respective plurality of intermediate values of the optical property vary monotonically between the first region and the second region.

In Example 19, the subject matter of Examples 11-18 includes, manufacturing the waveguide according to the design.

Example 20 is a device comprising: means for propagating light; a first region comprising a plurality of first diffractive means, each first diffractive means having a first value of a first physical property giving rise to a first value of an optical property in the first region; a second region comprising a plurality of second diffractive means, each second diffractive means having a second value of the first physical property giving rise to a second value of the optical property in the second region; and at least one interstitial region located between the first region and the second region, the at least one interstitial region comprising a plurality of interstitial diffractive means, each interstitial diffractive means having a value of at least one additional physical property different from the first physical property, the value of the at least one additional physical property giving rise to an intermediate value of the optical property in the at least one interstitial region, the intermediate value being between the first value and the second value of the optical property.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Other technical features may be readily apparent to one skilled in the art from the figures, descriptions, and claims herein.

### GLOSSARY

“Extended reality” (XR) refers, for example, to an interactive experience of a real-world environment where physical objects that reside in the real-world are “augmented” or enhanced by computer-generated digital content (also referred to as virtual content or synthetic content). XR can also refer to a system that enables a combination of real and virtual worlds, real-time interaction, and 3D registration of virtual and real objects. A user of an XR system perceives virtual content that appears to be attached to, or interacts with, a real-world physical object.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure. “Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A waveguide, comprising:
a first region comprising a plurality of first diffractive structures, each first diffractive structure having a first value of a first physical property giving rise to a first value of an optical property in the first region;
a second region comprising a plurality of second diffractive structures, each second diffractive structure having a second value of the first physical property giving rise to a second value of the optical property in the second region; and
at least one interstitial region located between the first region and the second region, the at least one interstitial region comprising a plurality of interstitial diffractive structures, each interstitial diffractive structure having a value of at least one additional physical property different from the first physical property, the value of the at least one additional physical property giving rise to an intermediate value of the optical property in the at least one interstitial region, the intermediate value being between the first value and the second value of the optical property.

2. The waveguide of claim 1, wherein:
the plurality of interstitial diffractive structures having the value of the at least one additional physical property is more manufacturable than a hypothetical plurality of diffractive structures having an intermediate value of the first physical property between the first value and the second value of the first physical property.

3. The waveguide of claim 1, wherein:
the first physical property comprises a width of a channel between adjacent diffractive structures.

4. The waveguide of claim 3, wherein:
the at least one additional physical property comprises a depth of the channel.

5. The waveguide of claim 3, wherein:
the at least one additional physical property comprises dimensions of a bridge joining the adjacent diffractive structures across the channel.

6. The waveguide of claim 1, wherein:
the first physical property comprises a width of a raised portion of the diffractive structures.

7. The waveguide of claim 6, wherein:
the at least one additional physical property comprises a height of the raised portion of the diffractive structures.

8. The waveguide of claim 1, wherein:
the at least one additional physical property comprises at least one of:
a depth of a channel between adjacent diffractive structures;
a height of a first raised portion of the diffractive structures;
a height of a second raised portion of the diffractive structures;
a length of a channel between adjacent diffractive structures;
an angle of a sidewall of the diffractive structures;
a depth profile of a sidewall of the diffractive structures;
a blaze angle of a staircase structure of the diffractive structures;
an orientation of the diffractive structures;
a thickness of a coating on the diffractive structures; or
a refractive index of a coating on the diffractive structures.

9. The waveguide of claim 8, wherein:
the at least one additional physical property comprises at least two of:
a depth of a channel between adjacent diffractive structures;
a height of a first raised portion of the diffractive structures;
a height of a second raised portion of the diffractive structures;
a length of a channel between adjacent diffractive structures;
an angle of a sidewall of the diffractive structures;
a depth profile of a sidewall of the diffractive structures;
a blaze angle of a staircase structure of the diffractive structures;
an orientation of the diffractive structures;
a thickness of a coating on the diffractive structures; or
a refractive index of a coating on the diffractive structures.

10. The waveguide of claim 1, wherein:
the at least one interstitial region comprises a plurality of interstitial regions arranged between the first region and the second region such that the respective plurality of intermediate values of the optical property vary smoothly and monotonically between the first region and the second region.

11. A method, comprising:
obtaining a desired optical property of a waveguide to be varied between a first region and a second region of the waveguide;
determining a first physical property of diffractive structures that can be varied to modulate the desired optical property;
determining at least one additional physical property of the diffractive structures that can be varied to modulate of the desired optical property, the diffractive structures being more manufacturable with variation of the at least one additional physical property than variation of the first physical property; and
generating a design for the waveguide comprising at least one interstitial region located between the first region and the second region, the at least one interstitial region comprising a plurality of interstitial diffractive structures, each interstitial diffractive structure having a value of the at least one additional physical property, the value of the at least one additional physical property giving rise to an intermediate value of the optical property in the at least one interstitial region, the intermediate value being between a first value of the optical property in the first region and a second value of the optical property in the second region.

12. The method of claim 11, wherein:
the first physical property comprises a width of a channel between adjacent diffractive structures.

13. The method of claim 12, wherein:
the at least one additional physical property comprises a depth of the channel.

14. The method of claim 12, wherein:
the at least one additional physical property comprises dimensions of a bridge joining the adjacent diffractive structures across the channel.

15. The method of claim 11, wherein:
the first physical property comprises a width of a raised portion of the diffractive structures.

16. The method of claim 15, wherein:
the at least one additional physical property comprises a height of the raised portion of the diffractive structures.

17. The method of claim 11, wherein:
the at least one additional physical property comprises at least two of:
a depth of a channel between adjacent diffractive structures;
a height of a first raised portion of the diffractive structures;
a height of a second raised portion of the diffractive structures;
a length of a channel between adjacent diffractive structures;
an angle of a sidewall of the diffractive structures;
a depth profile of a sidewall of the diffractive structures;
a blaze angle of a staircase structure of the diffractive structures;
an orientation of the diffractive structures;
a thickness of a coating on the diffractive structures; or
a refractive index of a coating on the diffractive structures.

18. The method of claim 11, wherein:
the at least one interstitial region comprises a plurality of interstitial regions arranged between the first region and the second region such that the respective plurality of intermediate values of the optical property vary monotonically between the first region and the second region.

19. The method of claim 11, further comprising:
manufacturing the waveguide according to the design.

20. A device comprising:
means for propagating light;
a first region comprising a plurality of first diffractive means, each first diffractive means having a first value of a first physical property giving rise to a first value of an optical property in the first region;
a second region comprising a plurality of second diffractive means, each second diffractive means having a second value of the first physical property giving rise to a second value of the optical property in the second region; and
at least one interstitial region located between the first region and the second region, the at least one interstitial region comprising a plurality of interstitial diffractive means, each interstitial diffractive means having a value of at least one additional physical property different from the first physical property, the value of the at least one additional physical property giving rise to an intermediate value of the optical property in the at least one interstitial region, the intermediate value being between the first value and the second value of the optical property.
